(19) United States
(12) Patent Application Publication
(10) Pub. No.: US 2022/0051588 A1
(43) Pub. Date: Feb. 17, 2022

(54) Technology to Train Speech Perception and Pronunciation for Second-Language Acquisition

(71) Applicant: Thomas David Kehoe, Boulder, CO (US)

(72) Inventor: Thomas David Kehoe, Boulder, CO (US)

(21) Appl. No.: 16/994,768

(22) Filed: Aug. 17, 2020

(51) Int. Cl. G09B 19/06; G09B 5/06; G10L 25/51; G10L 15/02; G10L 15/00

(52) U.S. Cl. CPC G09B 19/06; G09B 5/065; G10L 2015/025; G10L 15/02; G10L 15/005; G10L 25/51

(57) ABSTRACT

A technology to teach speech perception, including phonetics, phonology, and word and phrase segmentation from the audio stream, and pronunciation for second-language acquisition. The technology parses sentences or phrases into words, then learners parse words into phonemes, and then pronounce the words and phrases. Learners receive immediate feedback for each phoneme click. Learners' pronunciation is evaluated by an automatic speech recognition (ASR) program. Vernacular material such as videos and podcasts are presented. Data visualizations include a view for instructors to see correct and incorrect responses for each member of a class, and a view of an individual's phonemes to see which phonemes are difficult for that individual.

### BACKGROUND OF THE PROBLEM

“I couldn't seem to get hold of the language that everyone else was using so casually, and this made me feel foolish and inadequate. It was like being trapped in a maelstrom. I could find no center to hold on to, no beginning to start from. [I had been taught lists of French words] but I was having trouble now picking any of them out from the language that was spoken in the classroom. At home, every word had been like a strange and unique bird. But at school the words seemed to swoop across the sky like a flock, no single bird distinguishable from the whole.” (Pamuk, 2019)

Many second language (L2) learners report that when they travel to a foreign country, they can't understand native speakers, and native speakers can't understand the learners, even after a learner has studied a language for years and earned A grades.

Universities typically use the Grammar-Translation Approach which was historically used in teaching Greek and Latin and has been generalized to modern languages. Classes are taught in the students' L1 (native) language, with little active use of the L2 (target) language. Vocabulary is taught in the form of isolated word lists. Extensive grammar is taught, in the form of rules. Little or no attention is given to pronunciation. This approach works well with dead languages but doesn't teach one to have conversations with native speakers.

In the past, universities used the Audiolingual Approach to teach listening and speaking with repetitive drills. Grammar was taught inductively. Vocabulary was limited and learned in context. This approach is not widely used today because it's difficult, frustrating, and many students fail or drop out.

Universities send students on a junior year abroad to learn to speech perception and pronunciation. This suggests that universities aren't able to teach students to hear and speak a language.

Phonetics and phonology are usually taught as a senior-level course for language majors after they return from a junior year abroad. Students report that phonetics and phonology is the class that makes the language “click” and then they can hear and speak the language.

Brain imaging has found that listening to foreign speech elicits increased activity in the language-responsive cortex, until a threshold is reached, after which a cessation of activity is seen. Listening harder makes it worse. Different people have different thresholds. Polyglots have efficient auditory processing, giving them a high threshold, and enabling them to easily learn languages by ear. At the other end of the spectrum, about 10% of the population has auditory processing disorders that make learning a spoken language difficult (Thurman, 2018; Jouravlev, 2020).

University courses typically teach about 2000 words. This is sufficient for intermediate level conversation. But native speakers may use as many as 500,000 words; for example, Spanish verbs can have as many as 25 conjugations. Understanding native speech can't be done with a simplified version of a language.

Another problem is that many teachers are not native speakers of the target (L2) language and teach the L2 language with L1 pronunciation. E.g., students who learn L2 English from an L1 Chinese teacher may learn to pronounce English using Chinese phonemes, stresses, and rhythms. One study found that Korean university learners could understand other Korean students speaking English with better than 90% comprehension but had less than 10% intelligibility with Americans (Koo, 2017).

Technology is increasingly used to learn languages, especially apps. But apps typically also utilize the Grammar-Translation Approach, teaching vocabulary lists and grammar rules. Many apps now provide Automatic Speech Recognition (ASR) to test a learner's pronunciation. But online speech recognition services can't teach how to pronounce L2 words. E.g., if the target word is pronounced iðo but the learner produces ido, ASR can't tell the learner to produce the dental fricative ð instead of the alveolar stop d. (These characters are from the International Phonetic Alphabet or IPA.)

The need exists for improved training of speech perception and pronunciation for second-language acquisition. In particular, a technology is needed that can enable L2 learners that listen to foreign speech without overwhelming their auditory processing and shutting down their language-responsive cortex. Such an advance would be especially helpful for learners with auditory processing disorders.

### PRIOR ART

Duquette (U.S. Pat. No. 10,262,550, 2019, “Dynamic feedback and scoring of transcription of a dictation”) teaches a system for a student to transcribe a video “while providing real time feedback of correct, incorrect, and misplaced characters as well as visually pointing out the location of missing letters and missing words.” Typed characters are displayed in black or red indicating correct or incorrect letters. “Not only is final correctness assessed, but also the difficulty in getting to the final state of correctness is assessed.” This patent is licensed to Yabla, an app marketed to universities and, according to a sales rep, “is about listening to native speakers to increase your comprehension, spelling, and vocabulary skills.” Yabla plays videos with L2 (target language) captions and L1 (native language) subtitles. Learners may click words they don't recognize to see a definition. A speed control enables slowing the videos. Learners type what they heard, receiving immediate feedback on each word (black, red, or a blank space when a learner skips a word). Typing teaches correct spelling and incorrect pronunciation. For example, typing hijo suggests that the word rhymes with yo-yo, when the IPA transcription is ixo (i.e., Yabla doesn't teach the voiceless velar fricative x). Yabla lacks ASR so a learner won't realize that he or she is mispronouncing a word. Videos are long and will overwhelm a learner with a low language-responsive cortex threshold, even if played at the slowest speed. Merzenich (U.S. Pat. No. 5,813,862, 1998, “Method and device for enhancing the recognition of speech among speech-impaired individuals”; see also Tallal (U.S. Pat. Nos. 6,071,123, 6,071,123, 6,123,548, 6,302,697, 6,413,092 through 6,413,098) teaches that:

“The reception of, or learning of, a foreign language in an indigenous environment is difficult and sometimes almost insurmountable for normal individuals because of the speed at which the language is spoken. Foreign languages are consequently learned by rote memorization and repeated practice exercises, with the speed of talking increased commensurate with the ability to understand the spoken language. There is no set means for individuals learning a foreign language in the indigenous environment (that is, in the native country of the language) except by asking the foreign language speaker to ‘slow down’ or to ‘repeat’. Most of the problems in learning foreign languages in this indigenous environment can be attributed to the lack of recognition in the temporal processing of fast events in one's brain of the incoming speech sounds.

“While the phonemes of foreign languages differ in construction from the English language, the principles behind all spoken languages remain constant. That is, all languages can be broken down into fundamental sound structures known as phonemes. It is the recognition of these phonemes, such as the consonant-vowel syllables /ba/ and /da/ in the English language, that form the basic building blocks that must be learned. As with the L/LD [language-based learning disabled] individual, the foreign language student does not recognize these phonemes reliably when they are presented at their normal element durations and normal element sequence rates by native language speakers. As with L/LDs, they can be accurately distinguished from one another and can be correctly identified when the speech is artificially slowed down.”

In 1997 Scientific Learning Corporation, founded by Paula Tallal and Michael Merzenich, launched its Fast ForWord language-based audiovisual games for children four to fourteen intended to correct “a rapid auditory temporal processing deficit that compromises the development of phonological representations” (Strong, 2011). The app trained children to hear the difference between phoneme pairs such as p and b. A widely reported press release claimed that children with Specific Language Impairment (SLI) who were academically many years behind their peers had used Fast ForWord for a few weeks, and then advanced multiple grade levels in a few months. Five systematic reviews of more than thirty studies found “no significant effect of Fast ForWord on any outcome measure” (Strong, 2011), except for two investigations of Fast ForWord's effects on young English Language Learners (ELL) from kindergarten to sixth grade that found positive effects for spoken English but not for reading (Strong, 2011), i.e., Fast ForWord was only effective for spoken second language acquisition.

Haruta (U.S. Pat. No. 9,489,854, 2016, “Computing technologies for diagnosis and therapy of language-related disorders”) teaches a computer system for diagnosing and treating auditory processing disorders:

“. . . the patient hears strings of words containing /p/ or /b/ in a random order, such as staple, clamber, or flappy. The patient is asked to pick out only words that have /p/. If the patient makes no error in this cell, then the process generates a next cell B with the /pr/-/br/ contrast in word-initial position, such as prim, or brim. If the patient makes no error again, then the process proceeds onto a next phonemic contrast in a sequence, which is It/-/d/.”

In other words, the learner hears audio recordings of words with specific sounds, and then is asked to click one of two buttons. One button represents one phoneme, and the other button represents a second phoneme. In this example, the phonemes are /p/ and /b/, which are phonetically close and are difficult for persons with auditory processing disorders to distinguish.

When the learner correctly identifies the phonemes, then the computer system moves on to combinations of phonemes, such as /pr/ vs. /br/. When such combinations are completed successfully, the computer system moves on to another pair of single phonemes, such as /t/ and /d/.

Haruta also teaches monitoring processing speed, i.e., how quickly the learner clicks the correct phoneme key. This can indicate whether the learner is performing the task easily or with difficulty.

Haruta also teaches “sound-symbol matching,” in which the learner types to indicate which phoneme he or she heard.

Next, Haruta teaches syllabification and word segmentation. “The patient is then asked to segment these words into individual sounds, giving finer detail of her phonemic ability.”

Next, the learner listens to words and then spells (types) them (word-level sound-symbol matching): “For example, if she misspells blubber as blummer, then such error confirms that she has difficulty with the /b/-/m/ contrast in the word-medial position. However, if she spells bubble correctly in a same task, then this result would suggest that her problem may be confined to the /b/-/m/ contrast in word-medial position only when the word ends with /r/.”

Haruta also teaches “. . . sentence-level and text-level tests [that] may involve reading or writing.”

Haruta also teaches geolocation of the learner's computer to change the provided languages materials “based on a language or a dialect associated with that geolocation.”

Haruta also teaches that the system “can be configured for second language learning.”

Haruta doesn't teach pronunciation, except for a study of junior high school students with articulation disorders who were taught to pronounce their native language through the use of “. . . hand-held mirrors to check on the movement of their lips (lip spreading or rounding) and lollipops to feel the position of their tongues in vowel production.” These exercises are unrelated to Haruta's invention and not covered in his claims.

Dohring (U.S. Pat. No. 9,058,751, 2015, “Language phoneme practice engine”) teaches an app for learning English phonemes. The learner sees a chart of 45 phonemes (American English has more or less 54 phonemes), displayed with some odd spellings, instead of IPA characters. The learner can click to hear the phoneme, then pronounce and record the phoneme, then play back the learner's recording. The app has screens for single phonemes, words starting with a target phoneme, words with the target phonemes in the middle of the word, and words ending with the target phoneme. Dohring doesn't teach a pronunciation engine to evaluate the learner's pronunciation, nor does Dohring teach parsing words into phonemes.

Gottesfeld (WO-1999013446A1, 1999, “Interactive system for teaching speech pronunciation and reading”) teaches a system for pronunciation training in which a speech recognition algorithm compares a student's pronunciation to a correct pronunciation.

Palacios (U.S. Pat. No. 8,408,913, 2013, “System, method, computer program and data set which are intended to facilitate language learning by means of sound identification”) explains clearly and at length the problems of speech perception in second-language acquisition: “It is well known that foreign language students in particular have great difficulty in mastering the sounds of the foreign language being learned.” Additionally, Palacios teaches that, “the main problem of the learners of pronunciation is the interference that exists between visual form and phonological form.” E.g., Americans learning Spanish pronounce “bien” with two vowels, a long /e/ and a short /e/, because that is how the word is spelled. The correct pronunciation, however, has only the single rising diphthong /je/, which is not found in English.

Palacios teaches “. . . that using written text too early in the process of language learning creates difficulties for learning phonetics and phonology.” Palacios' solution is to teach foreign words not as they are written but with “a sequence of graphical characters . . . . These graphical entities might be, for example, a line, or a sequence of characters, of a waveform, or other type of entity that has some linear characteristic. The invention creates a correspondence between the fragments of such graphical entities and the language fragments on which the learner is working, so that it allows the learner to indirectly access the content of the samples of target language that he/she is examining.”

It might be simpler to teach second-language learners the International Phonetic Alphabet (IPA) and teach the second language in IPA characters. This wouldn't help if the learner's native language doesn't match the IPA, e.g., the English /j/ matches the IPA /dz/, when the IPA /j/ matches the English /y/.

Kehoe (US-20120164609, 2012, “Second Language Acquisition System and Method of Instruction”) teaches a system that “trains the user's brain's auditory processing area to recognize phonemes, syllables, and words of a foreign language, by presenting videos of a word or phrase spoken at a slow rate and at a normal rate, and an interface for the user to enter the phonemes, syllables, and words that he or she has heard, with immediate responses indicating correct or incorrect entries.” Kehoe does not teach pronunciation, such as the use of ASR.

The Examiner's response to Kehoe included the following references:

Baker (US-2005/0255431, “Interactive language learning system and method”) taught a method (FIG. 3) in which a learner reads text aloud and a speech recognition system checks if the learner read correctly, and then measures the learner's pronunciation proficiency. Baker also taught using audio and video materials (paragraph 42), and then breaking up continuous audio streams of spoken languages into simpler or more basic units, such as phrases, words, and phonemes (sounds). It's doubtful that Baker's system was reduced to practice, as in 2005 computers could barely understand words and phrases, and no one at this time (2020) has invented a speech-to-text app that can recognize phonemes.

Shpiro (US-2002/0150869, “Context-responsive spoken language instruction”) taught a device for “targeted practice on phoneme stress or pronunciation or intonation or rhythm language pronunciation.” Such a device is impossible, as stress, intonation, and language rhythm are on syllables, not phonemes. E.g., when a speaker says “the”, the speaker can't stress the voiced th consonant or the schwa vowel. Single-syllable words can't have stresses within a word. Only multi-syllable words have stresses, intonation, and rhythm.

Wood (U.S. Pat. No. 7,818,164, 2010, “Method and system for teaching a foreign language”) taught a method of foreign language instruction “where the target foreign language and [user's native or base] language are intermixed or ‘woven,’ e.g., by replacing words and phrases in a text in the base language with words and phrases in the target foreign language,” for example, “The dog ran to the arbor or “”Je suis a girl.” Wood taught using this method in written, audio, or video materials.

Escalante (US-2003/0228561, “Repetitive learning system and method”) taught “a system or method that allows [immigrant] workers [who don't speak English] to receive the needed language training while on the job, but does not take significant time away from the job.” A lesson-developer observes a worker performing a task and then designs a series of short lessons related to the task. The immigrant employee then alternately learns a lesson and then performs the task, repeating this pattern until the language skills are learned for that task.

Floven (US-2002/0046200, “System and method for individually adapted training”) taught a “Personal Language Trainer” that monitors and stores in a database which lessons (such as words) have been given to a user, where a user requested help, etc., thus providing “individually adapted training.”

Leem (U.S. Pat. No. 7,044,741, 2006, “On demand contents providing method and system”) taught a system in which “individuals may learn foreign languages easily, at lower cost, in a pleasant and convenient way.” Leem taught retrieving multiple audio recordings from a database and putting them together according to a script customized for the user's learning level. Leem also taught adjusting the speed of audio recordings.

Johnson (US-2007/0015121, “Interactive Foreign Language Teaching”) taught an “interactive lesson module . . . that prompts a user to repeat, translate, or define words or phrases, or to provide words corresponding to images, at a controllable difficulty level,” possible interacting with a “virtual character.”

Neff (US-2009/0217196, “Web-Based Tool for Collaborative, Social Learning”) taught a “social network” in which “a community of users . . . learn a language or help others learn a language” in “an immersive, collaborative environment.”

Anguera (U.S. Pat. No. 7,596,499, 2009, “Multilingual text-to-speech system with limited resources”) taught a text-to-speech converter in which a single speaker's voice can be made to speak in multiple, foreign languages.

All other patents containing the phrase “speech perception” and the phrase “second language” or “foreign language” are summarized in the “Appendix—Prior Art Search Results.” Additionally, the most recent 250 patents containing the word “pronunciation” and the phrase “second language” were surveyed and some are summarized in the appendix. These patents are not considered relevant to the present invention.

### OBJECT OF THE INVENTION

The primary object of the invention is to train speech perception for second-language acquisition, that is, to help learners to understand spoken foreign languages. Speech perception is divided into three fields: phonetics, or the phonemes (sounds, such as vowels and consonants) of a language; phonology, or the rhythms of a language, such as stressed syllables and short and long duration vowels; and, most importantly, word and phrase segmentation from the audio stream, in other words, training one's auditory processing to hear foreign speech as words and phrases instead of gibberish.

Another object of the invention is to train pronunciation for second-language acquisition.

An additional object of the invention is to aid second-language learners who have auditory processing disorders that affect their speech perception and pronunciation abilities.

A related object of the invention is software that can build a dictionary containing any or all words in a language, including conjugations. In contrast, existing dictionaries (printed or online), contain only lemmas, e.g., million but not millions, and run but not ran.

### SUMMARY OF THE INVENTION

The invention will be referred to as LanguageTwo, the name of the web app (https://languagetwo.com/) that is an embodiment of the invention.

LanguageTwo is available for English (ESL) and Spanish, plus demos of Chinese and Finnish. It is suggested at this point to watch the 90-second demo video available at LanguageTwo.com, and then login and try one of the videos.

Learners select from
Vocabulary, which feeds the most frequently used words to learners.
Word search, for any word in English or Spanish.
Videos (FIG. 1), podcasts, television shows, movies, etc.

Each video is cut into segments of a half-dozen words. Each word is provided with a clear computer-synthesized voice. The learner can select accent (e.g., Castilian vs. Latin American Spanish), gender, and speed. Some words are provided in two or three pronunciations, e.g., in English for has a reduced pronunciation that sounds like fur when we say, “two for a dollar.”

The learner sees the language's phoneme chart, with vowels, diphthongs, and consonants (FIG. 2).

The learner clicks the phonemes that he or she heard, receiving immediate feedback (green or red IPA characters) for correct (FIG. 3) and incorrect clicks (FIG. 4).

The learner can also click buttons for a hint (the next phoneme) or to reveal the word.

After correctly perceiving the word, the learner pronounces the word, again receiving immediate feedback for correct or incorrect pronunciations (FIG. 5). When all the words in the phrase are completed, the learner pronounces the phrase, again receiving immediate feedback from the ASR.

### Prior Art Analysis

There is considerable interest in pronunciation training at this time, and little interest in speech perception. This is reflected in the prior art.

No prior art connects or combines speech perception with pronunciation. Auditory processing is almost unmentioned in the prior art.

None of the prior art teaches parsing words into phonemes, except Haruta (2016, “The patient is then asked to segment these words into individual sounds, giving finer detail of her phonemic ability.”) and Kehoe (2012), neither of which teach pronunciation.

No prior art teaches phonology, or the rhythms of a language such as stressed syllables and short and long duration vowels.

No prior art teaches word and phrase segmentation from the audio stream.

The use of automatic speech recognition (ASR) is mentioned only in the most recent prior art.

Therefore, a system for second-language acquisition that includes parsing target language words into phonemes, teaching phonology such as stressed syllables and short and long duration vowels, and word and phrase segmentation from the audio stream, and then testing pronunciation with the aid of automatic speech recognition (ASR) appears to be novel. Using the app is the best way to experience its utility. The entire field of speech perception is non-obvious, as few individuals are aware of this aspect of L2 learning.

### BRIEF DESCRIPTION OF THE DRAWINGS

FIG. 1: Watching the music video “Gozando en la Habana,” with a word provided in three computer-synthesized voices, selectable for accent, gender, and speed . . . Error! Bookmark not defined.

FIG. 2: English phoneme chart, with 15 vowels and diphthongs and 25 consonants . . . Error! Bookmark not defined.

FIG. 3: Correct phoneme click (green) . . . Error! Bookmark not defined.

FIG. 4: Incorrect phoneme click (red) . . . Error! Bookmark not defined.

FIG. 5: Pronouncing cuéntame. The word is written in Spanish and IPA, translated into English, and the ASR pronunciation engine rated the learner's pronunciation 0.63 on a scale of 0 to 1. A big green “Double success!” button indicates that the learner perceived and pronounced the word correctly . . . Error! Bookmark not defined.

FIG. 6 was in the PPA but was removed before filing the non-provisional application

FIG. 7: English schwa vowel with tooltip . . . Error! Bookmark not defined.

FIG. 8: English schwa vowel with tooltip . . . Error! Bookmark not defined.

FIG. 9: Spanish vowel . . . Error! Bookmark not defined.

FIG. 10: Finnish vowel . . . Error! Bookmark not defined.

FIG. 11: Chinese vowel with tooltip . . . Error! Bookmark not defined.

FIG. 12: English consonants minimal pairs . . . Error! Bookmark not defined.

FIG. 13: English consonant combinations . . . Error! Bookmark not defined.

FIG. 14: Chinese tones . . . Error! Bookmark not defined.

FIG. 15: Incorrect pronunciation, “some” instead of “from” . . . Error! Bookmark not defined.

FIG. 16: Correct but poor pronunciation . . . Error! Bookmark not defined.

FIG. 17: Correct, clear pronunciation . . . Error! Bookmark not defined.

FIG. 18: Video practice, “want” . . . Error! Bookmark not defined.

FIG. 19: End of video clip . . . Error! Bookmark not defined.

FIG. 20: Correct pronunciation of phrase . . . Error! Bookmark not defined.

FIG. 21 was in the PPA but was removed before filing the non provisional application

FIG. 22 was in the PPA but was removed before filing the non provisional application

FIG. 23: Dictionary data structure, words . . . Error! Bookmark not defined.

FIG. 24: Dictionary data structure, pronunciations . . . Error! Bookmark not defined.

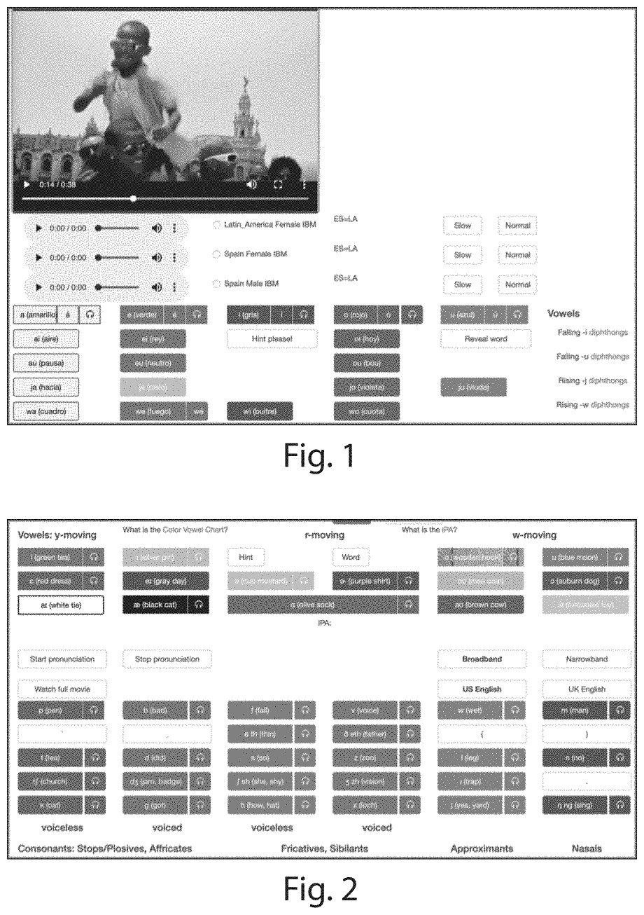

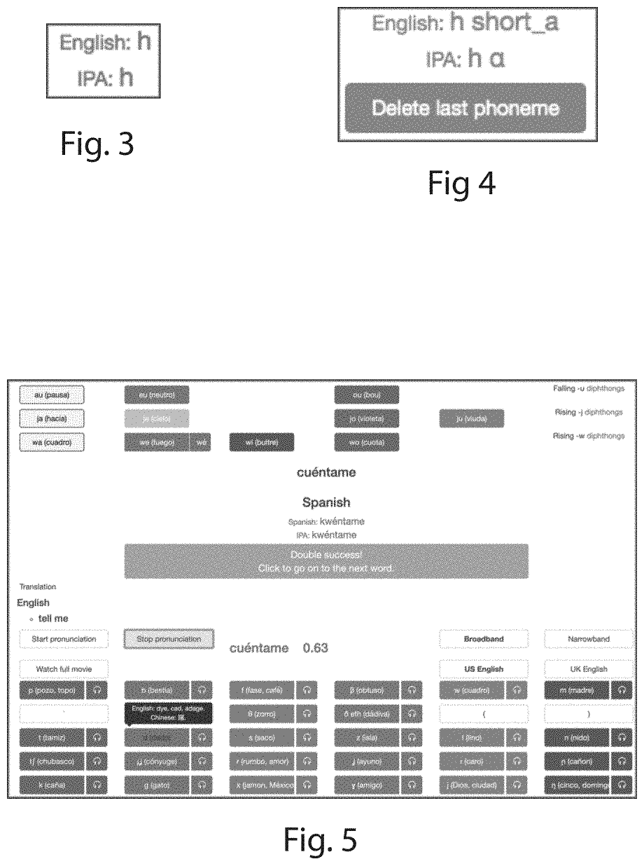

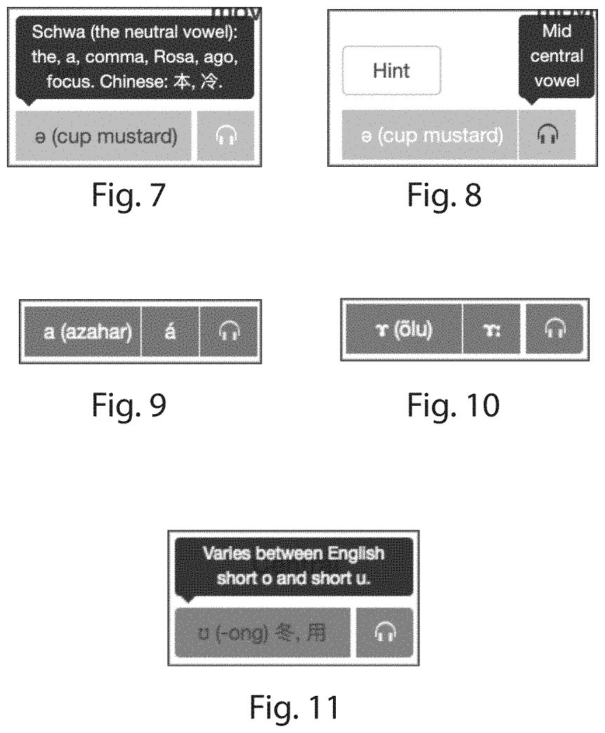

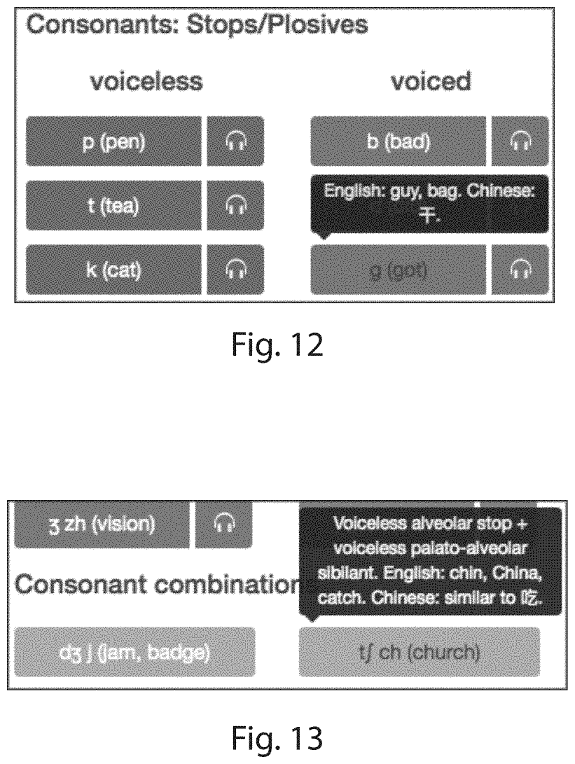

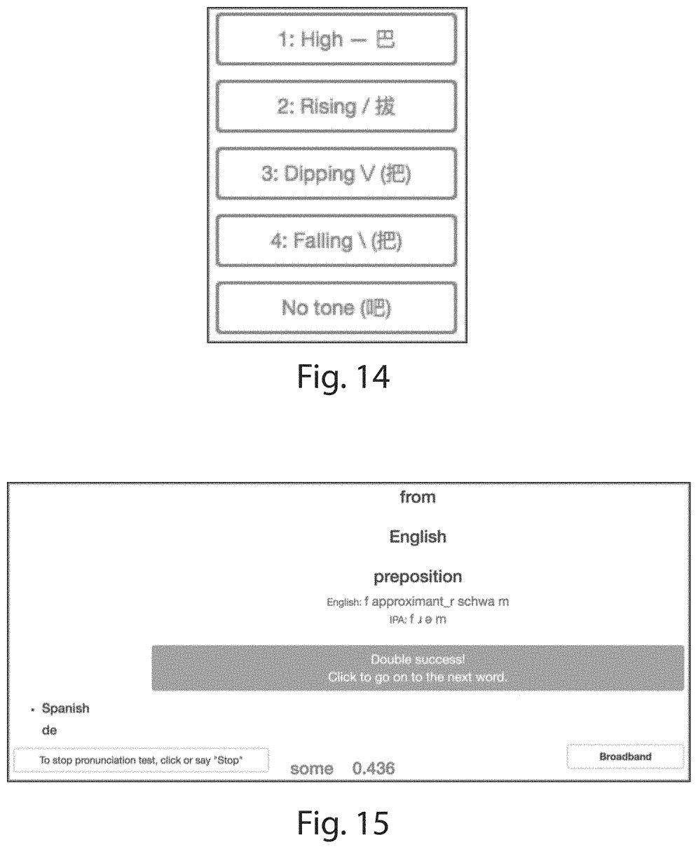

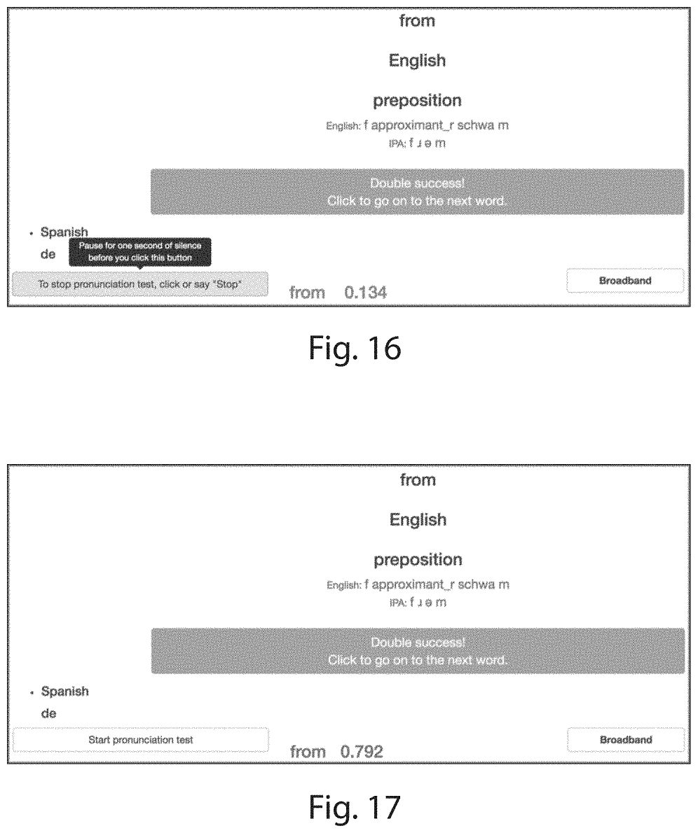

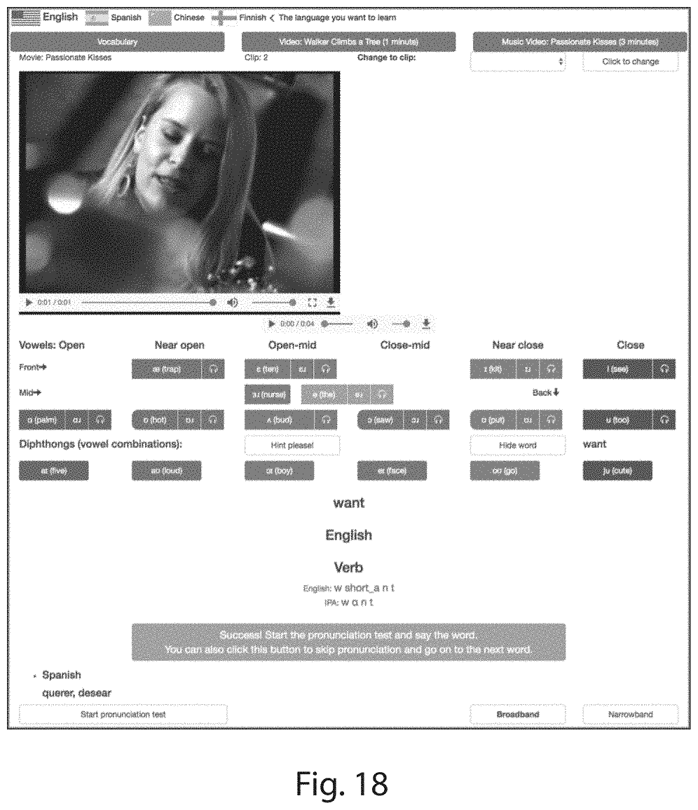

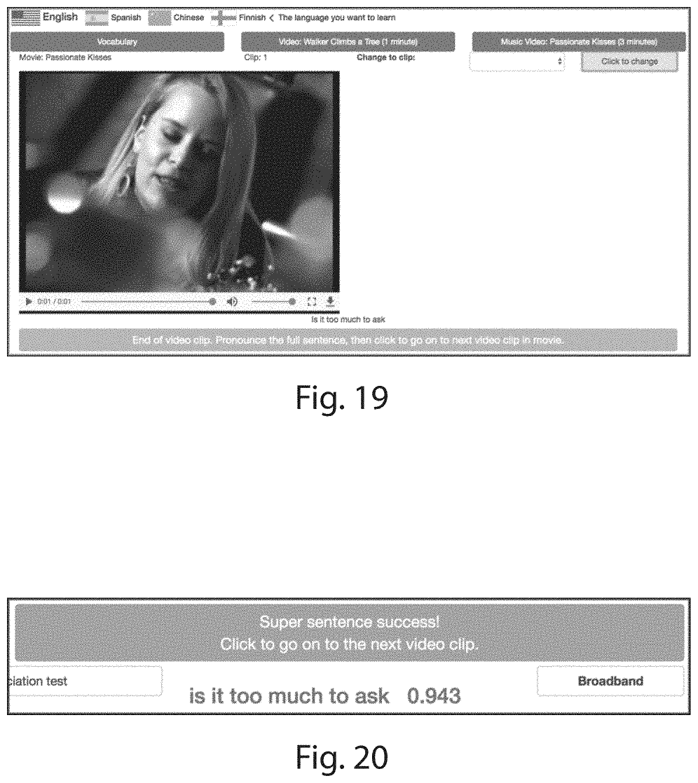

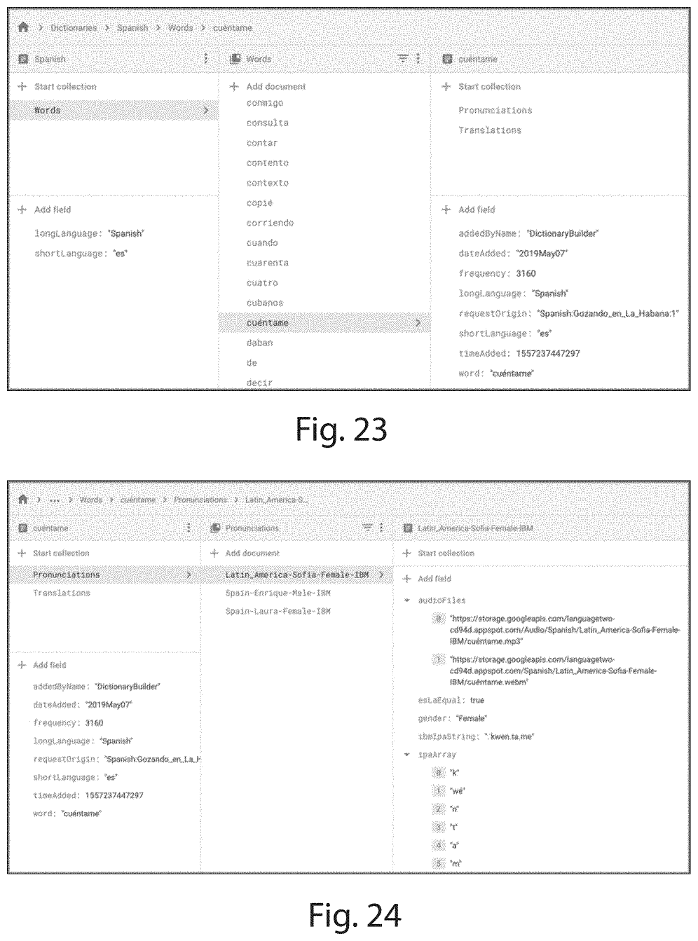

### DETAILED DESCRIPTION

LanguageTwo is a web app in the JavaScript computer language. In other words, going to the domain https://languagetwo.com downloads a computer program that runs on the learner's computer, within any modern browser, such as Chrome, Firefox, or Safari, independent of and safely isolated from the computer's operating system. LanguageTwo is built using a model-view-controller structure, in which Google's Angular framework and Angular Material design library support the views (what the learner sees) and the controllers (the logic behind the views). The data model is provided by Google's Firebase, a NoSQL cloud database.

A close examination of LanguageTwo phoneme buttons reveal a wealth of information.

The primary button shows the IPA character. The primary button also shows example words. The primary tooltip shows the name of the phoneme, and more example words, sometimes in multiple languages.

The secondary button shows a headphones icon indicating that the learner can listen to the phoneme. The tooltip provides the anatomical description of the phoneme.

Other languages have middle buttons for variations of the phoneme (almost always vowels).

Spanish vowels are accented or unaccented.

Finnish vowels (and some consonants) are short or long duration. The latter are indicated by the : mark. (English doesn't have the vowel shown in the figure.)

The Chinese (Mandarin) buttons display the Pinyin transcription in addition to the IPA character and an example word with a traditional Chinese character and with a simplified Chinese character. The tooltip describes the vowel to a native English speaker (no example English word is provided because English doesn't have this vowel).

Error! Reference source not found. shows pairs of English consonants. Note that the consonants are grouped into minimal pairs, in these cases, the voiceless and voiced stops or plosives. A tooltip over the /g/ displays examples of the consonant in the initial and final positions, plus a Chinese (Mandarin) example word.

Error! Reference source not found. shows two English consonant combinations, with example words, and a tooltip displayed for the right consonant combination.

Error! Reference source not found. shows the Chinese tones.

Haruta teaches “sound-symbol matching,” in which the learner types to indicate which phoneme he or she heard. Typing on a keyboard would be problematic in English because English phonemes don't match English letters. A keyboard also would be problematic in Chinese, as Chinese characters aren't phonetic. In other words, Haruta fails to teach “sound-symbol matching” in which the learner clicks buttons on a screen, in which the buttons represent phonemes, and.

### Pronunciation

After successfully parsing the word into phonemes, the learner then pronounces the word. LanguageTwo currently uses the IBM Watson artificial intelligence (AI) speech recognition (speech-to-text) engine for pronunciation evaluation. Other AI speech recognition engines are available, including Google Voice and Carnegie-Mellon University's Sphinx Project. IBM Watson is preferred because it runs in the browser (on the learner's computer), when Google Voice requires running code on the server.

An incorrect pronunciation displays what the learner said in red.

Error! Reference source not found. shows an incorrect pronunciation. The user said “some” instead of “from.” The word is displayed in red. Note that the box to the left indicates that the pronunciation test is not over.

Error! Reference source not found. show a correct but poor pronunciation. Ratings from 0.00 to 0.49 are considered poor pronunciations and display the word in red. Note that the box to the left indicates that the pronunciation test is not over.

Error! Reference source not found. shows a correct, clear pronunciation of “from.” The word is displayed in green. Note that the box to the left indicates that the pronunciation test is complete.

The learner than clicks the large green box to go to the next word.

### Phoneme Selection—Speedy Option

An optional switch enables the learner to switch the phoneme charts to “speedy” mode.

For example, a Spanish-language learner starts with the Spanish phoneme table. The word loaded into the audio player is “bailar,” or to dance. The learner clicks the /b/ phoneme.

The screen changes, eliminating all phonemes except the vowels /a/, /e/, /i/, /o/, and /u/; the diphthongs /ai/, /au/, /ui/, and the consonants /l/ and /r/. These are the most common phonemes that can follow /b/ in Spanish. Also visible, but partially opaque (“grayed out”) are the diphthongs /ei/, /oi/, /ou!. These are less common phonemes following /b/.

If the learner selects /a/ as the second phoneme, the screen changes again to show /l/, /n/, /ñ/, /r/, /s/, and /t/. These are the most common phonemes that follow /ba/ in Spanish. Also visible, but partially opaque are /b/, /ch/, /d/, /g/, /m/, and /z/. These are less common phonemes following /ba/. Also visible but partially opaque and with a contrasting border color are /k/ and /p/, which only follow /ba/ in foreign words imported into Spanish.

### Vernacular Materials

The learner can choose to learn with vernacular materials instead of working on vocabulary. The term “vernacular materials” here includes podcasts, audiobooks, movies, television series, and music videos.

Error! Reference source not found. shows the music video “Passionate Kisses,” with Mary Chapin Carpenter. The learner has correctly parsed the phonemes for the word “want” but has not yet pronounced the word.

Vernacular materials are split into phrases of a few words, typically five or six words. This may only be two seconds of video. The learner watches the video in the video player, then clicks to hear each word in the audio player. These are the same words that are used in vocabulary practice, i.e., single words spoken clearly. The learner than parses the phonemes and clicks the phoneme buttons, then pronounces each word, as was described for vocabulary practice. The difference is that when the learner completes the phrase, the full phrase is displayed, and the learner pronounces the phrase.

Error! Reference source not found. shows the message displayed when the learner completes each word in a video clip. The full phrase is displayed, in this case, “Is it too much to ask”. The learner the pronounces the full phrase.

A correct pronunciation is displayed in green (Error! Reference source not found.), with a large green button for the learner to click to go on to the next video clip.

A music video typically has about twenty short clips. When the learner completes the all the clips, the learner can watch the complete video and view a full script, e.g., the lyrics of the song. Instructors might assign a music video as homework, and then when the students return to class the instructor might lead the students singing the song.

Thus, in perhaps an hour of work, a second language learner can learn to perceive and pronounce an entire music video.

### Instructor Data Visualizations

LanguageTwo also includes data visualizations for second language instructors. An instructor can click to see a data visualization of his or her entire class, with each student represented by a set of graphical bars. Each student has a green bar for correct phoneme clicks and a red bar for incorrect phoneme clicks. Each student also has a blue bar for correct pronunciations and an orange bar for incorrect phoneme clicks. The widths of the bars indicate how fast the students are responding, e.g., a thin green bar indicates fast, correct responses; when a thick red bar indicates slow, incorrect responses. The length of the bar indicates how many clicks or words s student has completed, thus a long bar indicates that a student has completed many words, when a short bar indicates that a student hasn't been using LanguageTwo.

An instructor can thus see at a glance which students are doing well and which students need help. The instructor can then click on a student and see a data visualization of which phonemes the student had problems with, i.e., many slow, red clicks on /p/ indicates that the student is having difficulty with this phoneme.

Another data visualization shows the instructor the entire class, broken down by phoneme. This might indicate that many students are having difficulty with the voiced /th/, for example.

### Syllable Parsing

When the second-language learner has completed the phoneme parsing phase, perhaps by completing a certain number of correct phoneme clicks in a certain amount of time, with correct pronunciations within a certain amount of time, then the student may move on to syllable parsing. The first screen shows all of the syllables of the language. When the learner clicks on the correct syllable, the screen changes to show only the syllables that follow the previous syllable.

### Word and Phrase Segmentation from the Audio Stream

Phrase segmentation, i.e., splitting phrases and sentences into words, is one of the important, yet poorly understand, functions of auditory processing. When a LanguageTwo learner has mastered parsing words into phonemes, he or she can work on parsing phrases or sentences into words. This is accomplished by presenting a phrase or sentence, and then the learner typing the words.

### Dictionary Builder

As each word is prepared for a learner, the software looks for the word in the LanguageTwo cloud database. If the word isn't in the database, a Google Cloud Function is called to build a dictionary entry. LanguageTwo is capable of presenting a word in English or Spanish, including plurals and conjugations, proper names, place names, etc., for a total of hundreds of thousands of words in each language. Additional languages will be added in the future.

The dictionary builder functions are complex and different for each language. For English, the function first calls the Oxford English Dictionary application programming interface (API). The OED provides a wealth of information about more than 100,000 English words, including different pronunciations, for example, for is often pronounced like fur when we say, “Two for a dollar.” Each pronunciation has an IPA transcription and a computer synthesized audio file. The OED audio files are extremely clear and lifelike, although selecting gender and speed isn't available at this time. Accent is selectable for British or American accents.

The OED only provides lemmas, i.e., no plurals or conjugations. The OED provides a lemmatron that, when given a plural or conjugation, returns the lemma, but this results in, for example, requesting millions and getting back million. If for this reason or any other reason the OED returns with an error message that a word is not in the OED, the function goes to IBM Watson. IBM Watson can handle lemmas, e.g., requesting millions returns millions. IBM Watson provides only a single pronunciation for each word, and the quality of the speech synthesis isn't perfect, so the OED is preferred.

Translations are preferred from the OED because it returns every translation of a word, when IBM Watson and Google typically return only one translation.

Spanish dictionary building is handled differently because there is no resource as complete as the OED. First, an IPA transcription is built using custom software developed by LanguageTwo with the assistance of Ph.D. Spanish linguist at the University of Colorado. While it is often said that Spanish is pronounced the way it's spelled, there are dozens of rules, e.g., this letter is pronounced like this if it follows that letter but pronounced in a different way when it follows another letter.

Spanish audio files are then requested from IBM Watson, which provides three voices: male Castilian, female Castilian, and female Latin American. An IPA transcription is provided, which is not typically used but is sometimes tested against the LanguageTwo IPA transcription software. We discovered that IBM Watson was making mistakes transcribing Spanish diphthongs. We brought this to the attention of the team at IBM and they thanked us.

### Data Structures

Google Firebase's Firestore NoSQL realtime cloud database is used. The dictionaries are structured with collections for pronunciations and translations, and fields for the language, the date added, what video or podcast the word occurs in, etc.

The pronunciations collection is structured with different pronunciations by accent, voice, gender, and source, e.g., Latin America, Sophia, female, and IBM Watson.

Each pronunciation then has audiofiles in one or more formats, such as mp3 and webm. Each pronunciation also has an IPA transcription, as both a string and an array.

### Transcranial Direct Current Stimulation

Transcranial direct current stimulation (tDCS) uses electrodes to deliver a small electrical current to a subject's head. tDCS is non-invasive, low cost, simple, and safe. tDCS applied to a brain region can facilitate brain states that improve (or suppress) different forms of cognition, such as learning, memory, attention, or perception (Knotkova, 2019).

tDCS has been extensively investigated with visual perception and motor learning, and a small number of studies have investigated the impact of tDCS on auditory perception, including pitch perception and auditory temporal information processing (Shah-Basak, 2019). A few studies have shown benefits in language and verbal learning. Several studies investigated word and pseudoword (made-up words) learning (Flöel, 2008; Perceval, 2017; Javadi, 2012; Javadi, 2013), which is similar to learning vocabulary lists in a foreign language course or app. One study investigated verbal fluency (producing as many words as possible starting with a specific letter in one minute), with no significant results (Radman, 2018).

Repeated or daily use of tDCS over the course of weeks can result in longer-lasting effects that may last weeks or months, and possibly longer (Shah-Basak, 2019). A study found after five days of language training with tDCS, a steeper learning curve and improvement in overall task performance in subjects receiving real stimulation compared with sham stimulation, which was maintained for at least a week after the training ended (Meinzer, 2014).

No studies have investigated tDCS with second language (L2) speech perception or pronunciation training. LanguageTwo teaches the type of learning the tDCS is effective for, combining auditory learning (listening to words and phrases) with visual and motor movements (clicking buttons in a phoneme chart).

1. Technology for second-language acquisition that enables a learner to parse a target language word into phonemes, with evaluation of said phoneme parsing, then said learner pronouncing said word with said pronunciation evaluated by automatic speech recognition (ASR).

2. The technology of claim 1, in which a phoneme chart of a language is presented, in which each phoneme is presented as a selectable button.

3. The technology of claim 2, in which phonological features of a language, such as stressed vs. unstressed phonemes, long vs. short duration phonemes, or tones that alter pitch to distinguish lexical or grammatical meaning, are presented as separate buttons.

4. The technology of claim 2, in which a button displays the International Phonetic Alphabet (IPA) symbol for a phoneme.

5. The technology of claim 2, in which a button displays an example word for a phoneme.

6. The technology of claim 2, in which selecting a phoneme button plays a recording of said phoneme.

7. The technology of claim 1, in which said learner is able to select a button to view a next correct phoneme.

8. The technology of claim 1, in which said learner is able to select a button to view said target language word.

9. The technology of claim 1, in which a learner can search for a word.

10. The technology of claim 1, in which a plurality of pronunciations of said target language word are presented.

11. The technology of claim 1, in which an audio recording of said target language word is presented to a learner and said learner may select the gender of the speaker of said recorded word.

12. The technology of claim 1, in which an audio recording of said target language word is presented to a learner, and said learner may select the accent, dialect, or regional variation of the speaker of said recorded word.

13. The technology of claim 1, which stores a list of target language words said user has correctly completed, and records how many times said user has correctly completed each word, and no longer presents a word to said user after said user has correctly completed said word a predetermined number of times.

14. The technology of claim 1, in which correctly vs. incorrectly parsing a phoneme displays said phoneme in a particular color, such as green or red.

15. The technology of claim 2, in which selecting a phoneme button hides or de-emphasizes phonemes that never or rarely follow said selected phoneme.

16. The technology of claim 1, which presents a data visualization of a group of learners correct and/or incorrect responses for phoneme parsing and/or pronunciations.

17. The technology of claim 16, in which said data visualization includes the time to reach said state of correctness.

18. The technology of claim 1, in which a dictionary entry for a word is automatically built, by connecting to databases or other sources of information via application programming interface (API), with information in one or more of the following fields: language, usage frequency rank in the language, part of speech, phonemes, one or more translations into other languages, the language of a translation, the etiology of said word, the grammar of said word, and/or one or more audio and/or video files.

19. The technology of claim 1, in which cognition and learning are improved with the use of transcranial direct current stimulation (tDCS).

20. The technology of claim 1, in which said target language words are derived from an audio or video recording of a native speaker of said target language.

21. The technology of claim 20, in which a long audio or video recording is presented to said learner in short clips comprising phrases or sentences of three to fifteen words.

22. The technology of claim 21, in which said learner's pronunciation of said phrases or sentences is evaluated using Automatic Speech Recognition (ASR).
